(19) United States
(12) Patent Application Publication
(10) Pub. No.: US 2002/0010780 A1
(43) Pub. Date: Jan. 24, 2002

(54) Method and system for selectively receiving content over a communications network based on network communication speed

(76) Inventors: Norman C. Wong, Kanata (CA); Paul R. Cowles, Ottawa (CA); Rodney (Todd) Sandor, Kanata (CA); Tiet Cuong Yu, Scarborough (CA)

Correspondence Address: DANA L. TANGREN, WORKMAN, NYDEGGER & SEELEY, 1000 Eagle Gate Tower, 60 East South Temple, Salt Lake City, UT, 84111, US

(21) Appl. No.: 09/876,798

(22) Filed: Jun. 7, 2001

(30) Foreign Application Priority Data
Jun. 7, 2000 (CA) 2,313,298

(51) Int. Cl. G06F 15/173

(52) U.S. Cl. 709/226; 709/241

(57) ABSTRACT

A method and system selectively provide content to a user over a communications network based upon the detected bandwidth throughput or speed the user is experiencing while communicating over the network. The determination of the bandwidth throughput or speed is not based upon the access mechanism of the users (e.g., dial-up, DSL, cable modem), but is based upon the effective bandwidth throughput the user is experiencing. Briefly, according to the method, the speed is determined automatically; the content is selected based on the determined speed and communicated to the user. Speed may be determined automatically by measuring throughput at the user system or the server side. Preferably the speed is determined non-intrusively. Further preferably, the speed between the user and a particular server is determined for example by measuring the speed of the transfer of a plurality of data content items which measures may be averaged.

### CROSS-REFERENCE TO RELATED APPLICATIONS

The present application claims priority to Canadian Application No. 2,313,298, filed Jun. 7, 2000, which application is incorporated herein by specific reference.

### BACKGROUND OF THE INVENTION

1. The Field of the Invention

This invention relates generally to network communications and in particular to receiving content selected according to the speed (or throughput) of communications over the network. More particularly the invention provides a mechanism for Internet Web Servers to provide content to Web Surfers based upon the effective throughput speed to the site the Web Surfer is experiencing or the average surf speed over the web surfing session.

2. Background to the Invention

In a conventional network communications environment where a user such as a Web Surfer communicates over a network such as the Internet with a Server hosting a server application such as a Web Site, the content of the Web Site is provided to the user without much regard to the communications capabilities of the user. Typically users communicating with relatively slow capabilities, for example those connected to the network via a slower speed dial-up connection are treated equally with those having much higher speed capabilities such as those connected to the network via a cable modem.

Some Web Sites offer a choice for users to select content via a form query based on the type of connection the user may have. For example a web page may query a user to select further content based on dial-up, ISDN, DSL or another connection type. While user selective operation may enhance the surfing experience, some users do not know which connection type they have and, in any event, network congestion may render a high-speed connection no more effective than a slower speed connection.

Therefore it is desired to have a method and system for selectively receiving content over a communications network based on network communication speed that operates by automatically detecting the effective throughput speed.

### SUMMARY OF THE INVENTION

The invention provides a method and system for selectively providing content to a user over a communications network based upon the detected bandwidth throughput or speed the user is experiencing while communicating over the network. The determination of the bandwidth throughput or speed is not based upon the access mechanism of the users (e.g., dial-up, DSL, cable modem), but is based upon the effective bandwidth throughput the user is experiencing. Briefly, according to the method, the speed is determined automatically; the content is selected based on the determined speed and communicated to the user. Speed may be determined automatically by measuring throughput at the user system or the server side. Preferably the speed is determined non-intrusively. Further preferably, the speed between the user and a particular server is determined for example by measuring the speed of the transfer of a plurality of data content items which measures may be averaged.

When speed is determined at the user system, the speed is communicated to a device capable of selecting the content based on the speed. Preferably, the speed is communicated from the user to the device, such as a server, via cookies.

### BRIEF DESCRIPTION OF THE DRAWINGS

The characteristics and advantages of the invention are brought out in the following descriptions, given by way of example and illustrated in the attached drawings where:

FIG. 1 is a schematic view of an exemplary network communications system; and

FIG. 2 illustrates schematically network communications according to the invention between a user system (client) and a server system.

### TERMINOLOGY

LSP-Layered Service Provider: Provides an interface to the Winsock 2 TCP/IP stack.

Client Side Speed Enabled (CSE): Refers to the client side speed enabled technology implemented on the user system or client.

Server Side Speed Enabled (SSE): Refers to the server side speed enabled technology implemented on the server.

### DETAILED DESCRIPTION OF THE PREFERRED EMBODIMENTS

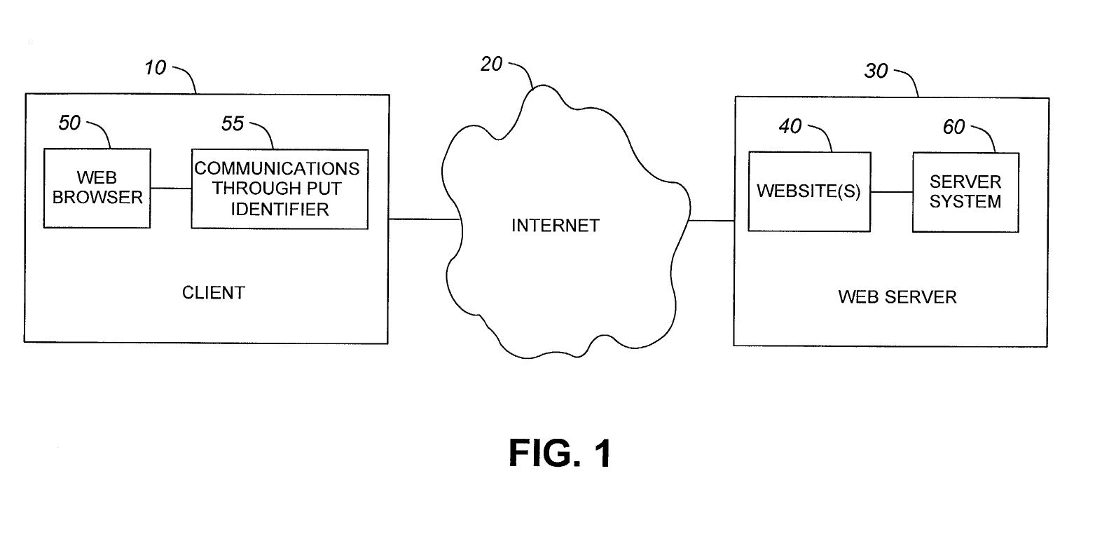

With reference to FIG. 1 there is shown a user system or client 10 comprising a computer system having a Windows™ operating system (e.g., Windows/98/NT/2000). The computer system is capable of connecting to a network 20 such as the Internet for communications with other devices such as a Web Server 30 comprising a computer having a Linux™ operating system and hosting one or more web sites 40. The user system 10 may connect to the network 20 in one or more of a variety of well-known manners such as by dial-up modem through a telephone system, by cable modem, DSL or ISDN etc (not shown). The user system 10 may connect to the network through another network such as a private LAN having a high speed or other network gateway connection (not shown). The user system further comprises software 50 for web site browsing. Optionally, the user system 10 may include client side software 55 for determining automatically the network communications speed of the connection between the user system 10 and the web site 40 when the system 10 is browsing.

The Server 30 includes server side software 60 that is capable of selecting content for communicating to the software 50 of the user system 10 depending on the connection speed of the user system. The server side software 60 may also be capable of determining automatically the speed of the connection of the user system 10. For the purposes of the invention only one or the other of the client side or server side need to be capable of determining the speed.

In the preferred embodiment, the underlying functionality of the speed-enabled technologies is to re-write specific cookies with values that are based upon the non-intrusive observation of the effective content throughput (in Kbits/second) or speed when the user system 10 interacts or browses with a web site. Web servers such as Server 30 provide speed aware content to end-users based upon the supplied cookie values.

The techniques used to determine the speed vary depending on whether the determination is at the client 10 side or server 30 side. The techniques used are explained in the client side and server side sub-sections below.

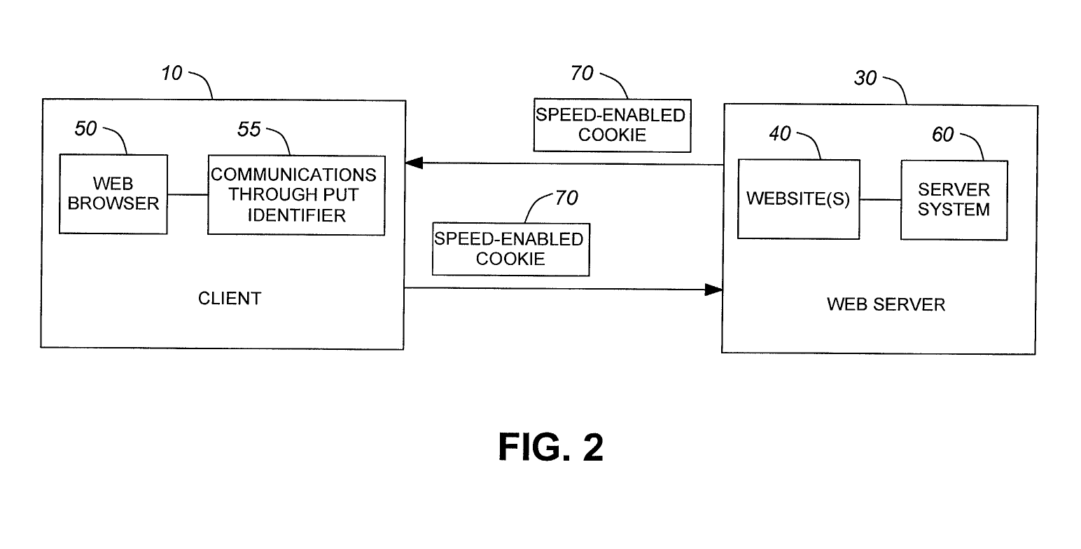

According to the preferred embodiment, the client 10 and server 30 communicate the speed information to the web server 30 by re-writing cookie values. With reference to FIG. 2, a speed enabled web server 30 sets a speed-enabled cookie 70 with appropriate defaults and communicates it to a user system 10 in response to a browse of a site hosted by the server 30. When the user system 10 sends the cookie back to the server, the client-side and/or server side speed-enable technology re-writes the cookie value with the speed information.

Cookies are well known in the art and are used to maintain state variables on the Web-the state information is maintained in the users browser. The following web pages provide more cookie information:

http://www.ietf.org/rfc/rfc2109.txt

http://home.netscape.com/newsref/std/cookie spec.html

http://www.cookiecentral.com/

Table 1 defines the cookie names and values that are re-written by the client 10 and server 30 speed enabled technologies. To allow for efficient implementation for both the Client and Server, cookie values must be the fixed length as represented in the table. The CSE (Client Speed Enabled) and SSE (Server Speed Enabled) annotations in the Description column indicate whether the client or server speed enabled technology re-writes the cookie value.

TABLE 1
Speed-Enabled Cookies

| | | Suggested | |
|---|---|---|---|
| | Cookie | Default | |
| Cookie | Value | Cookie | |
| Name | Length | Value | Description |
| WHAVG | 4 | 0000 | [CSE] The average speed (Kbits/ |
| | | | second) based upon the users recent |
| | | | surfing experience to the last 16 |
| | | | web sites visited. |
| WHAVGT | 1 | S | [CSE] The average speed, repre- |
| | | | sented as S, M and F (Slow, Medium, |
| | | | Fast) based upon the users recent |
| | | | surfing experience to the last 16 web |
| | | | sites visited. |
| WHCUR | 4 | 0000 | [CSE] The current speed (Kbits/ |
| | | | second) the user is experiencing to |
| | | | the current site. |
| WHSCUR | 4 | 0000 | [SSE] The current speed (Kbits/ |
| | | | second) the user is experiencing to |
| | | | the current site. |
| WHCURT | 1 | S | [CSE] The current speed, represented |
| | | | as S, M, F (Slow, Medium, Fast) to |
| | | | the current site. |
| WHSCURT | 1 | S | [SSE] The current speed, represented |
| | | | as S, M, F (Slow, Medium, Fast) to |
| | | | the current site. |

Table 2 provides the preferred ranges of speeds that are used for the three cookie text values [S (Slow), M (Medium), F (Fast)]. Tools and software libraries provided with the demo Server Side applications provide a mechanism that allow the server applications to define their own speed ranges by using the cookies that provide the speed in Kbits/second.

TABLE 2
Speed-Enabled Speed Ranges

| | | |
|---|---|---|
| Cookie Name | Cookie Value | Actual Speed (AS) |

| | | |
|---|---|---|
| WHAVGT, | S | AS <= 56 K bits/Sec |
| WHCURT, | | |
| WHSCURT | | |
| WHAVGT, | M | 56 > AS <= 384 K bits/Sec |
| WHCURT, | | |
| WHSCURT | | |
| WHAVGT, | F | AS > 384 K bits/Sec |
| WHCURT, | | |
| WHSCURT | | |

### Client Server Interaction

The speed-enabled technology requires the web server applications to be written to take advantage of the speed-enabled feature. The Server performs a set cookie operation for the speed-enabled cookies that their application supports (see Table 1).

As a simple example showing a single cookie, the following is the interaction at the HTTP level:

1. The Web Server serves a speed cookie to a client-agent.

Server→User Agent

HTTP/1.1 200 OK

Set-Cookie: WHCURT=“D”, Version=“1”, Path=“/acme”

2. When the client-agent visits the same site and the /acme URI, the browser will send the cookie. If the customer companion is installed, it will re-write the value of the cookie with the speed information, in this case the speed value “F” for the WHCURT cookie.

User Agent→Server

GET/acme/showme HTTP/1.1

Cookie: $Version=“1”, WHCURT=“F”; $Path=“/acme”

The Web-Server application, based upon the value of the WHCURT cookie, in this case “F”—will serve the user the so-called FAST content (e.g., video).

### Client Side Speed Enabled Technology

In the preferred embodiment, the client side speed enabled technology uses a LSP (Layered Service Provider) to detect the speed to web sites and to re-write the cookie values. The LSP maintains a speed-table that contains IP addresses, a timestamp and a number of throughput samples. In the table, each row contains the throughput information for a web site (based upon its IP address). An IP address only appears in a single row in the table (it will not appear more than once). The following table shows a single row with 8 throughput samples.

| Ip | Time | Sam- | Sam- | Sam- | Sam- | Sam- | Sam- | Sam- | Sam- |
|---|---|---|---|---|---|---|---|---|---|
| Ad- | Stamp | ple | ple | ple | ple | ple | ple | ple | ple |
| dress | | #1 | #2 | #3 | #4 | #5 | #6 | #7 | #8 |

The throughput information (i.e., sample) is maintained for the most recently visited web sites. The number of sites to maintain in the table may be pre-chosen to keep the overhead light and so as not to include a long history of sites whose speed values may not reflect current communications conditions. For example, a table having about 16 entries may be used.

Each sample in a row represents the effective throughput of a data content received from the web site. The method used for calculating the throughput is shown below.

The oldest IP address (based upon time stamp) is replaced when a new web site is visited and all rows are used. Each time a web site is accessed/re-accessed, the time stamp for the visited IP address in the table is updated.

When a new throughput sample for an IP address is calculated, it will replace the slowest throughput sample kept for the same IP address.

The current speed cookie value is calculated by taking the average of all non-zero throughput samples for the row that has the same IP address (if there is a match). This calculation is performed when the LPS needs to re-write a cookie value (WHCUR, WHCURT).

The average speed cookie value is calculated by taking the average of all non-zero throughput samples in the entire table. This calculation is performed when the LSP needs to re-write a cookie value (WHAVG, WHAVGT).

When the speed-table is empty, the LPS re-writes cookie values with 0 (WHCUR, WHAVG) or S (WHCURT, WHAVGT).

When users first start the browser and make the first request to the first-website, the speed-table will have some values as soon as the LSP encounters any object with size>1460 from this first-website. From this point, the LSP will overwrite the Cookie by averaging this first row in the speed-table. As long as the user system remains in this first website, the current speed will be equal to the average speed.

### Throughput Calculation Method

Table 3 provides some definitions/assumptions used for the throughput calculations. Data received from the web site is only used if the size of the data received is>1460 bytes.

TotalResponseTime (in milliseconds)—the elapsed time between the last byte in a send request and the last bytes in the response received. LostTime—the time it took the web server to process the request.

Thus, in the preferred embodiment, the following method is used:

If (received-data > 1460) {

OverHead = ( RecvSize / 1460) + 2) * 40;
ThroughPut = (RecvSize +OverHead) * 9 / TotalResponseTime;
If (ThroughPut > 0)

NewSpeed(Addr,ThroughPut); // Update a sample entry

}
Note: The “ThroughPut = (RecvSize +OverHead) * 9 /
TotalResponseTime” is uses as an efficiency optimization over
“ThroughPut = (RecvSize + OverHead) * 8 * 1024 /
(TotalResponseTime * 1000)” since 8 * 1024 / 1000) ˜(is approximately)
9.

TABLE 3
Client Speed-Enabled Assumptions

| | Definitions/Assumptions | Description |
|---|---|---|
| 1 | Assume the IP packet size used is | The LSP measures the |
| | 1500 bytes. Note: The maximum size | throughput at the Winsock |
| | (MTU − Maximum Transmissions | layer, so we assume the |
| | Unit) of a Ethernet frame is 1500 | maximum MTU is used. |
| | bytes (this includes the IP packet) | |
| 2 | Protocol Overhead = 40. | IP header 20 bytes, TCP |
| | We assume that IP options are not used | header 20 bytes. |
| | in the IP headers. | |
| 3 | Maximum data size per packet = | Content received >1460 |
| | 1500 − 40 = 1460 | bytes must arrive from |
| | | multiple IP packets. |
| 4 | Assume additional overhead of 80 | As an example, assume the |
| | bytes for content received <1460 | web server sends 1960 |
| | bytes. | bytes, based on a MTU of |
| | | 1500 bytes, this data must |
| | | be sent in two IP packets |
| | | (1^{st} 1460 bytes, 2^{nd} 500 |
| | | bytes). The overhead is |
| | | thus 80 bytes: 40 bytes for |
| | | the 2^{nd} packet plus the 40 |
| | | bytes required for the |
| | | empty TCP ACK packet. |

The preferred method of determining the network communications throughput on the client side is non-intrusive. Alternative methods, typically being intrusive, are also known. For example the user system could download a predetermined fixed piece of data such as a large HTML comment of a known size. The download can be timed and the throughput calculated posted back to the site via FORM or QueryString. Or, the user system may run an applet that talks back to server with speed of the throughput on a downloaded fixed data item. In such cases, additional data and extra communications overhead are required to measure and identify the throughput.

### Server Side Speed Enabled Technology

In the preferred embodiment, server side speed-enabled technology is implemented via sniffer-based technology. Sniffer technology is implemented as a network interface module that collects all network traffic between the clients (browsers) and the web server. This technology will measure RTT (Round Trip Time) and throughput between the client making the request and the server.

A small slice of software is inserted as a layer between the web-server and communications stack to re-write the cookie (WHSCUR, WHSCURT) value with the throughput information. The sniffer component uses an IPC (inter process communication) mechanism to control the cookie re-writing software.

The sniffer calculates the speed as follows:

a/T1: Time stamp at the first byte send out by web server (This is the reply send by web server to client)

b/T2: Time stamp when web server receives that ACK from the browser. (Browser say: web server, I've received all the data)

c/N : Total number of bytes (transmitted from web server to browser), all the web server reply with data size>1460 will be used to calculate user speed.

d/S: N/(T2−T1) (user Speed)

e/S (user speed) will be stored and make available to the web server on the same machine via an IPC.

It is understood that the server side speed enabled technology can be utilized at a point between the user system browser and the web content providing application such as may be hosted on a server. For example, the speed enabled technology can be incorporated at a web switch, such as a load balancer, or at a web caching device.

Cookie communications provide certain advantages as cookies are supported by Microsoft Internet Explorer™ and Netscape Navigator™ browsers among others.

The non-intrusive determination of throughput and cookie communications do not cause any appreciable overhead to end-users or non-participating web sites.

Cookies are not the only method of communication. Some user systems are disabled for cookies. Alternative communication methods are well known in the art. For example, the client side software could embed the determined speed in HEADER (user agent string etc). The speed may be added by querystring to every URL request. Speed may be sent by POST to each site or the client software could communicate to the web server on another port providing the client's speed and IP address. The web server then keeps a database of IPs and speeds for each client. It is apparent that some of these methods introduce significant overhead to the client and server.

The features of the invention may be easily integrated into a wide variety of web server applications. As well, features can be utilized by sites using load balancers. The load balancer can select a server farm to provide content to a user system based upon the value of a cookie from the user system indicating its speed.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

What is claimed is:

1. A method for selectively communicating a content over a communications network to a user system, the method comprising:
determining automatically a network communication throughput indicative of the communications performance the user system is experiencing;
selecting the content to be communicated based on the network communication throughput; and
communicating to the user system the content selected.

2. A method according to claim 1 whereby the act of determining automatically a network communication throughput comprises receiving said network communication throughput from the user system, said network communication throughput being determined automatically by the user system and being indicative of the communications performance the user system is experiencing.

3. A method according to claim 2 whereby the act of determining automatically a network communication throughput comprises re-writing cookies with values correlated to non-intrusive observation of effective real-time content throughput at said user system.

4. A communications system for selectively communicating a content over a communications network to a user system, the communications system comprising:
a communication throughput indicator component configured for determining automatically a network communication throughput indicative of the communications performance the user system is experiencing;
a selection component configured for selecting the content to be communicated based on the network communications throughput; and
a communicator component for communicating to the user system the content selected.

5. A communications system according to claim 4 wherein said communication throughput indicator component comprises a throughput receiver component configured for receiving said network communication throughput from the user system, said network communication throughput determined automatically by the user system and being indicative of the communications performance the user system is experiencing.

6. A communications system according to claim 5 wherein said communication throughput indicator component comprises cookies configured for re-writing with values correlated to non-intrusive observation of effective real-time content throughput at said user system.
